(19) United States
(12) Patent Application Publication
(10) Pub. No.: US 2012/0041879 A1
(43) Pub. Date: Feb. 16, 2012

(54) METHODS AND SYSTEMS FOR PAYMENT PROCESSING BETWEEN CONSUMERS AND MERCHANTS

(76) Inventors: Paul Kim, San Jose, CA (US); Changwon Choi, Fremont, CA (US); Daniel Kim, Sunnyvale, CA (US); Bobby Choi, Sunnyvale, CA (US)

(21) Appl. No.: 12/854,099

(22) Filed: Aug. 10, 2010

(51) Int. Cl. G06Q 40/00

(52) U.S. Cl. 705/44

(57) ABSTRACT

Described herein are methods and systems for processing a consumer payment with a payment system that utilizes payment information from a network partner of the payment system. In one embodiment, the payment system initiates a payment transaction between a merchant's site and the consumer in response to receiving a selection of a payment option from a consumer using an electronic device. The payment system generates selectable network partner options to be displayed on the electronic device of the consumer. The payment system receives a selection of one of the network partner options and also account credential information for the selected network partner from the consumer. The payment system sends the account credential information to the network partner for authentication. The payment system receives payment information for the consumer from the network partner. The payment system processes the payment transaction on behalf of the merchant.

### TECHNICAL FIELD

Embodiments of the present invention relate to methods and systems for payment processing between a consumer and a merchant with a payment system that utilizes a network partner of the payment system to provide payment information.

### BACKGROUND

The improvement of wireless mobile technologies and the Internet has led to various mobile payment systems. Currently, a mobile payment value chain involves mobile carriers. For one prior approach, a consumer shops for an item or content from a merchant's site. A payment processor processes the transaction on behalf of the merchant. The payment processor places the consumer purchase charge onto a mobile carrier's bill. The mobile carrier has a preexisting relationship with the consumer based on the mobile service provided by the mobile carrier to the consumer. The mobile carrier sends an invoice to the consumer for the consumer charge. The consumer typically remits payment within 30 days. The payment is primarily made with credit cards, debit cards, automated clearing house (ACH), or checks.

Mobile billing leverages a pre-existing account without forcing pre-registration on consumers. Mobile billing provides the convenience of paying with a mobile phone in a ubiquitous manner. Mobile billing can be secure and private with no need to expose a credit card. However, mobile carriers are slow to provide this mobile payment service and additionally charge high fees (e.g., transaction cost of 50% of the consumer purchase).

### BRIEF DESCRIPTION OF THE DRAWINGS

The present invention is illustrated by way of example, and not by way of limitation, in the figures of the accompanying drawings and in which:

FIG. 1 illustrates an exemplary payment transaction 100 that utilizes a network partner of a payment system according to one embodiment;

FIGS. 2 and 3 illustrate a detailed flow of a payment transaction 200 having no mobile carrier dependency and utilizing a network partner according to one embodiment;

FIGS. 4a-4d illustrate exemplary input windows for when a consumer selects a payment network transaction flow that utilizes consumer information from a network partner in accordance with one embodiment;

FIGS. 5a-5d illustrate exemplary input windows for when a consumer selects a payment network transaction flow that utilizes consumer information from a network partner in accordance with an embodiment;

FIG. 6 illustrates a flow diagram of an embodiment for a method 600 of performing a payment transaction with a payment system that utilizes a network partner;

FIG. 7 illustrates a flow diagram of one embodiment for a method 700 of performing a payment transaction with a payment system that utilizes a network partner;

FIG. 8 illustrates a flow diagram of one embodiment for a method 800 of initializing a payment transaction with a payment system that utilizes a network partner;

FIG. 9 illustrates a flow diagram of one embodiment for a method 900 of authenticating and verifying a consumer with a payment system;

FIG. 10 illustrates a flow diagram of one embodiment for a method 1000 of payment network processing;

FIG. 11 illustrates a flow diagram of one embodiment for a method 1100 of sharing payment information for a payment transaction utilizing a network partner system;

FIG. 12 illustrates a flow diagram of one embodiment for a method 1200 of completing a payment transaction;

FIG. 13 illustrates a system overview for a payment transaction with a payment system that utilizes a network partner system in accordance with certain embodiments;

FIG. 14 illustrates a network topology for a payment transaction with a payment system that utilizes a network partner in accordance with certain embodiments;

FIG. 15 illustrates a network topology for a payment transaction with a payment system that utilizes a network partner in accordance with another embodiment;

FIG. 16 illustrates a payment system for a payment transaction that utilizes a network partner system in accordance with one embodiment;

FIG. 17 illustrates a network topology for a payment transaction with a payment system that utilizes a network partner system in accordance with another embodiment; and

FIG. 18 illustrates a network topology for a payment transaction with a cloud service model and payment system that utilizes a network partner system in accordance with another embodiment.

### DETAILED DESCRIPTION

Described herein are methods and systems for processing a consumer payment with a payment system that utilizes payment information from a network partner of the payment system. In one embodiment, the payment system initiates a payment transaction between a merchant's site and the consumer in response to receiving a selection of a payment option from a consumer using an electronic device. Next, the payment system generates selectable network partner options to be displayed on the electronic device of the consumer. Each network partner is associated with one of the selectable network partner options. Each network partner partners with the payment system. The payment system receives a selection of one of the network partner options and also account credential information for the selected network partner from the consumer. The payment system sends the account credential information to the network partner for authentication. The payment system receives payment information for the consumer from the network partner if the consumer is successfully authenticated with the network partner. The payment system processes the payment transaction on behalf of the merchant. A consumer can quickly complete a payment transaction with a merchant even though the consumer has no payment method saved with this merchant. A payment method saved with the network partner is used to complete the transaction with the merchant.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

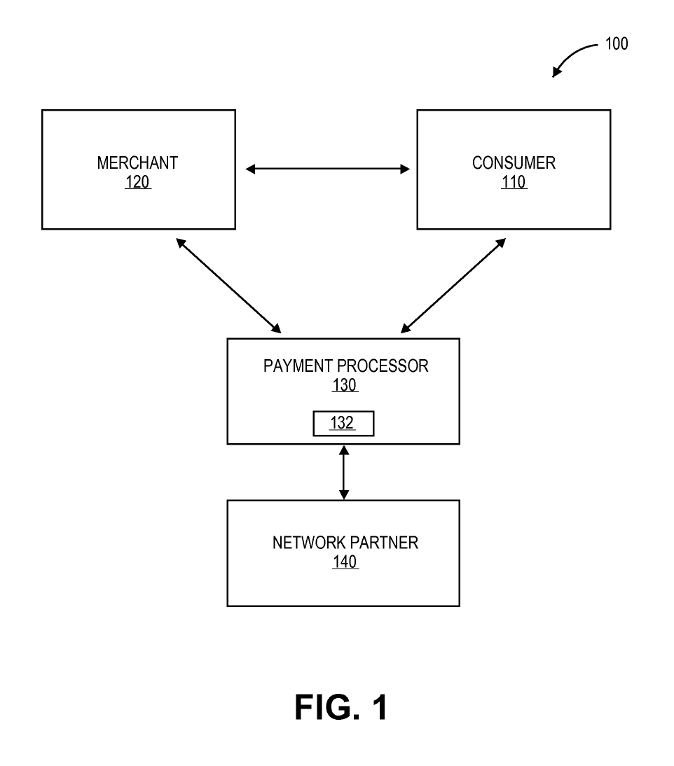

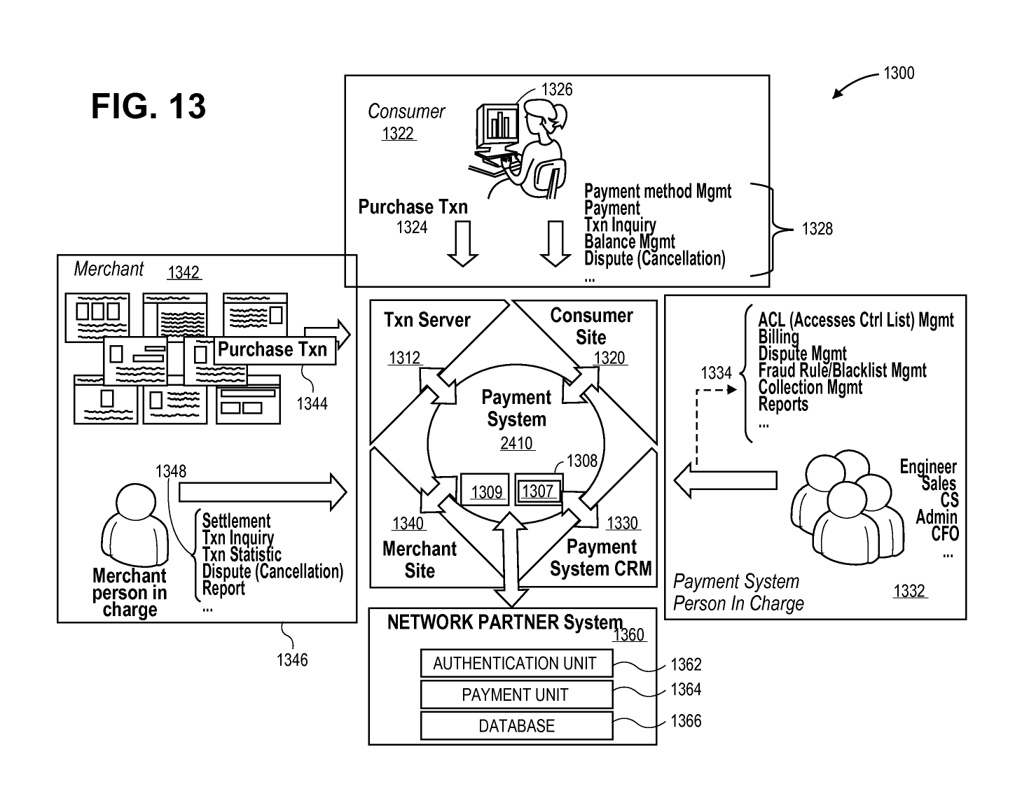

FIG. 1 illustrates an exemplary payment transaction 100 that utilizes a network partner of a payment system according to one embodiment. A consumer 110 shops for a product (e.g., item, content) or service from a merchant 120 (e.g., social media merchant, gaming merchant, retail merchant, etc.) with an electronic device (e.g., mobile device, computing device, computer, laptop, tablet, netbook, hand-held device, etc.). The consumer 110 may access the merchant's products or services via an online site of the merchant. In one embodiment, the consumer 110 selects a payment processor 130 from the merchant's site. The payment processor 130 may be, for example, a payment system having various hardware components (e.g., servers, gateways, payment network units, data centers, network routers, etc.) as described herein and illustrated in FIGS. 13-18. The merchant 120 sends purchase data to the payment processor 130. The purchase data may include, for example, a merchant identifier, a merchant name, a service identifier, a service name, a sku identifier, a sku name, a price, etc. The payment processor 130 processes the transaction based on a mobile number received from the consumer and while utilizing payment information from a network partner of the payment processor 130. The payment processor 130 processes the transaction on behalf of the merchant.

The payment processor 130 provides payment options to allow a consumer to quickly and easily complete payment transactions even with merchants that the consumer has no previous relationship or has no stored payment method. The consumer may not have confidence in using a payment method provided by certain merchants (e.g., smaller merchants, merchants with no previous relationship), but wants to purchase a product or service from these certain merchants. In this case, the consumer can use a payment method of the payment system or a network partner of the payment system that the consumer has already established a relationship and has confidence in the payment method of the network partner. A “network partner” can be defined as a company that maintains payment information (e.g., credit/debit card, bank ACH, etc.) on behalf of its customers. Possible examples of a network partner may include, but are not limited to, the following: larger merchants, online merchants (Amazon®, Overstock.com®, Macys.com®, Diapers.com®, etc.), online games (Blizzard®, Second Life, etc.), online dating (Zoosk.com®, Match.com®, etc.), software services (Symantec®, McAfee®, Adobe®, Microsoft®, etc.), utility services (AT&T, PG&E®, Comcast®, DishTV®, etc.), financial services (Mint.com, E*TRADE, etc.), eLearning (Kaplan, Princeton Review, etc.), mobile carriers, etc. The network partner may have a large database of users. This enables a consumer to make a payment to a smaller or unknown merchant using a payment method of a larger merchant that the consumer trusts.

Payment processing can occur in three different ways. For a consumer that already has an account with the payment processor 130, the consumer can instantly charge their selected payment option or debit their stored balance. The payment processor 130 provides various payment options (e.g., credit card, debit card, bank account, retail channel cash payments, mail-in payments, “spot me” payments, etc.). For a consumer who has one or more payment methods stored at a network partner 140, which partners with the payment processor 130, the consumer can use credential information (e.g., ID, password) for authenticating and accessing the network partner via a payment network (PN) unit 132 (e.g., payment network gateway) of the payment processor 130 in order to bill the stored payment method that is stored with the network partner. The payment processor 130 is the merchant of record for the payment transaction. The consumer's credential information for the network partner is utilized for the payment transaction.

The payment network unit 132 leverages the mobile payment process and transaction management infrastructure of the payment processor 30 to allow consumers who have accounts and payment instruments on file with a network partner to use the network partner's authentication method(s) to authenticate the consumer, then bill the payment instrument the consumer has on file with the network partner. For example, a consumer uses his ID/password at a network partner to charge his credit/debit card on file with the network partner. The payment processor 130 processes the transaction via mobile payments while the consumer purchases a product or service at a different merchant's online store.

The payment network unit 132 utilizes two-factor authentication using physical authentication via the mobile phone and secure account authentication through a network partner 140 of the payment processor 130. A network partner provides the payment information to the payment network unit 132 to complete the transaction through the payment processing infrastructure of the payment processor 130.

For a consumer that does not have an account with the payment processor 130 nor with a network partner 140 that partners with the payment processor 130, the consumer can receive micro-credit from the payment processor 130 without any pre-registration and receive the product or service from the merchant 120. The payment processor's proprietary risk management system proactively prevents fraudulent transactions.

The payment processor 130 may subsequently send a communication (e.g., SMS, email, etc.) to the consumer to have the consumer complete the transaction with post-registration and payment. The consumer performs post-registration and remits payment to the payment processor within a certain time period (e.g., 14 days). The payment processor 130 can provide numerous payment options including credit card, debit card, ACH, mailing in cash or money orders, paying at retail stores and kiosks (e.g., Coinstar®), a “billing one's parents” option, and other options as well. The payment processor 130 periodically pays the merchant 120 for the products or services provided to the consumer. The mobile payment transaction 100 provides immediate access to all mobile subscribers without charging a mobile bill and with no dependency on mobile carriers. Consumers having accounts with network partners, which partner with the payment processor 130, can advantageously use these accounts and associated payment methods for quickly and safely making purchases from a different merchant (e.g., merchant 120).

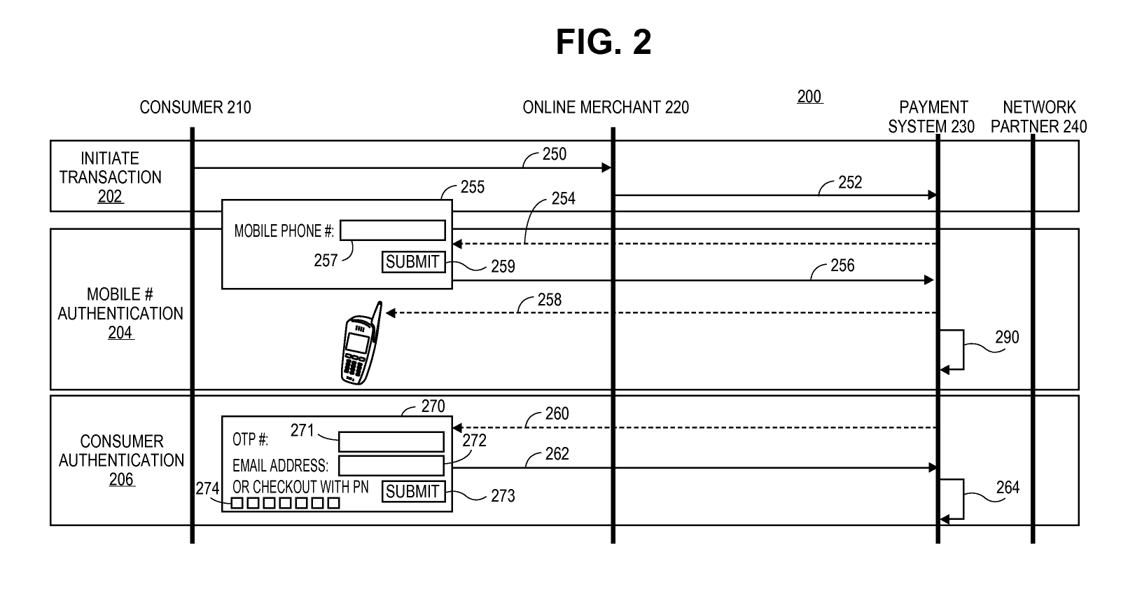

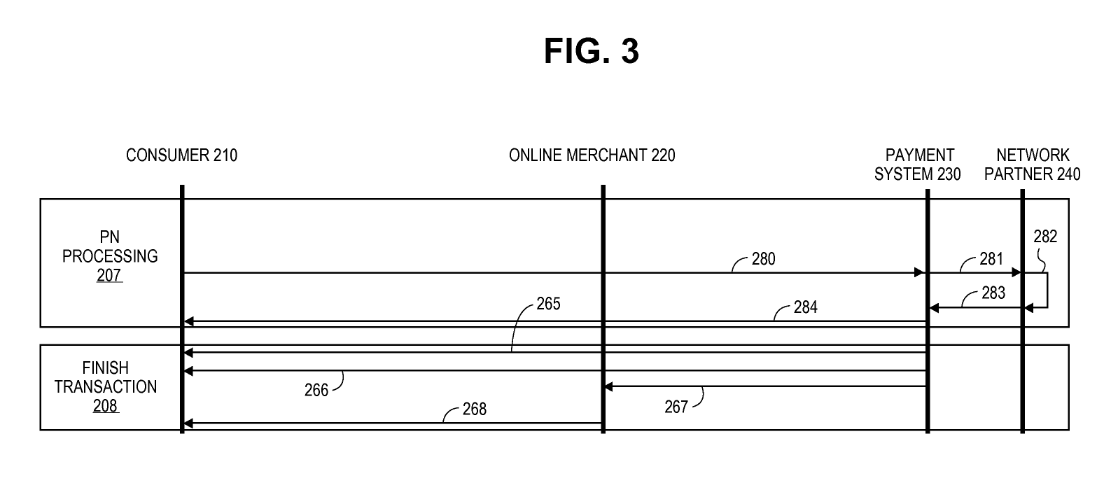

FIGS. 2 and 3 illustrate a detailed flow of a payment transaction 200 according to one embodiment. The mobile payment transaction 200 includes the following components: initiate transaction 202 (e.g., operations 250 and 252), mobile number authentication 204 (e.g., operations 254, 256, 258, and 290), and consumer authentication 206 (e.g., operations 260, 262, and 264) as illustrated in FIG. 2. The mobile payment transaction 200 also includes payment network (PN) processing 207 (e.g., operations 280-284) and finish transaction 208 (e.g., operations 265, 266, 267, and 268) as illustrated in FIG. 3.

At operation 250, a consumer 210 with an electronic device (e.g., mobile device, computing device, computer, laptop, tablet, netbook, hand-held device, etc.) shops for a product (e.g., item, content) or service from an online merchant's site and selects a payment option to purchase the product or service. At operation 252, the online merchant 220 sends a payment transaction request to a payment system 230 (e.g., payment processor 130). At operation 254, the payment system 230 generates a mobile phone input window 255 having an input region 257 that is displayed on the electronic device of the consumer. For example, the input window may be displayed within a web browser of the electronic device. FIG. 3 illustrates an exemplary window that may be generated as window 255. At operation 256, the consumer inputs to the region 257 a mobile phone number associated with a mobile device of the consumer and submits the mobile phone number to the payment system 230 by selecting the submit option 259. In one embodiment, the consumer accesses the online merchant with an electronic device other than a mobile device (e.g., data processing system, personal computer, laptop, netbook, etc.) and provides the mobile phone number of a mobile device used by the consumer. In another embodiment, the consumer accesses the online merchant with a mobile device and provides the mobile phone number of this mobile device.

At operation 258, the payment system 230 generates a one time passcode (OTP) that is sent to the mobile device after the received mobile phone number is verified by the payment processor. In an embodiment, the OTP is sent via SMS. At operation 290, the payment system 230 checks an internal database to determine whether the consumer is a registered user and whether this is the consumer's first transaction with the payment system.

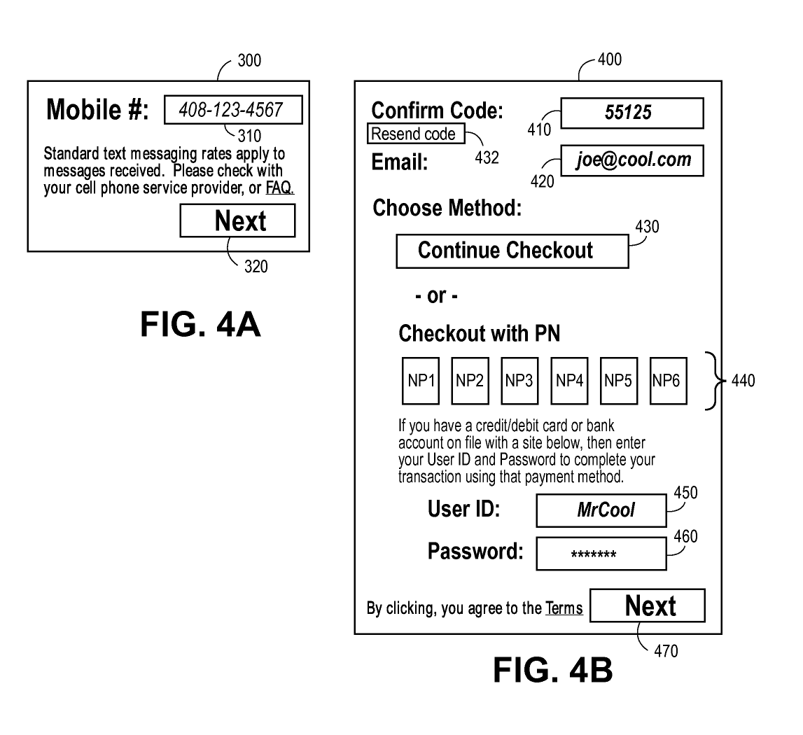

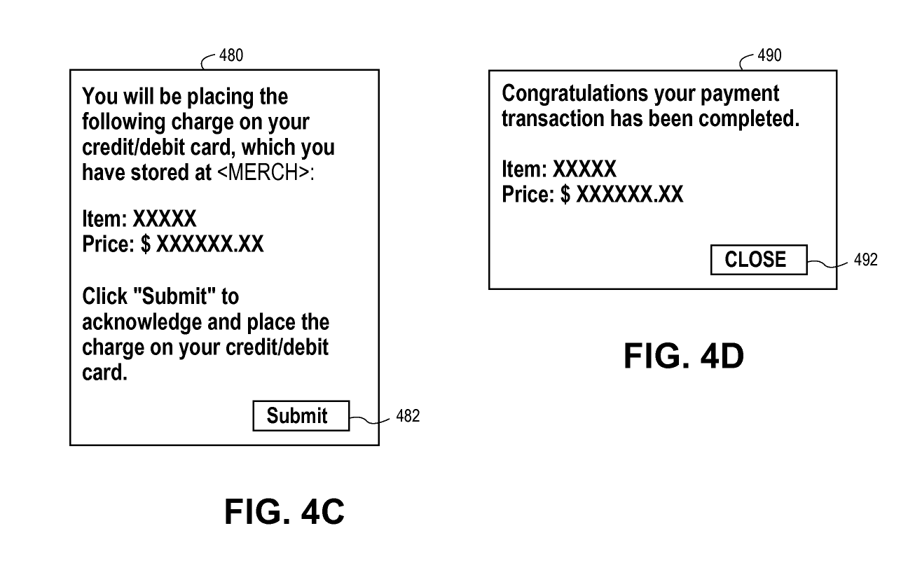

At operation 260, the payment system 230 refreshes the previous window with a OTP input window 270 according to some embodiments. The window 270 that is displayed on the electronic device depends on whether this is the consumer's first transaction with the payment system 230 and whether the consumer has registered previously with payment system 230. FIG. 4 illustrates an exemplary window that may be generated as window 270. The input window 270 includes an input region 271 for entering the OTP and an input region 272 for entering user contact information (e.g., an email address) for a first time transaction. If this is a second or subsequent transaction for the consumer with the payment system 230, then the email address input region is replaced with authentication information such as a personal PIN or a third party password (e.g., Facebook® password, Twitter® password, OpenID® password, etc.) input region. The input window 270 also includes PN processing with network partner options 274 that utilize credential information associated with a network partner, which is a partner of the payment processor. If a consumer selects a network partner option (e.g., network partner option 1, network partner option 2, network partner option 3, etc.), then credential fields (e.g., User ID, password) are dynamically generated and displayed on the window 270. The consumer enters the credential information to proceed with the payment transaction using a stored payment method of the selected network partner.

At operation 280, the consumer submits the credential information to the payment system 230, which sends this information to the selected network partner at operation 281. The network partner 240 confirms the account identity and also confirms if a payment option is stored with the network partner at operation 282. The network partner sends payment information (e.g., credit card information, debit card information, bank account information, prepaid account, etc.) to the payment system 230 at operation 283 if the consumer successfully authenticates with the network partner. At operation 284, the payment system 230 causes a confirmation message (e.g., confirmation page) to be displayed to the electronic device of the consumer in order to authorize the charge to the consumer's payment instrument. The payment system 230 then processes the payment through its own PN unit using the payment information received from the network partner.

If the network partner does not have any payment information for the consumer, then the consumer, at operation 262, submits the OTP and email address to the payment system 230 by selecting the submit option 273 for a first time transaction. Alternatively, at operation 262, the consumer submits the OTP and authentication information for a second or subsequent transaction. At operation 264, the payment system 230 authenticates the consumer with the two factor information provided by the consumer.

At operation 265, the payment system 230 notifies the consumer whether the transaction was successfully completed or failed. At operation 266, the payment system extends micro-credit to the consumer with no pre-registration if this is the consumer's first transaction with the payment system. The micro-credit may be limited to a certain amount (e.g., twenty dollars) for a first time consumer. At operation 267, the payment system 230 notifies the merchant whether the transaction was successfully completed or failed. Then, at operation 268, the merchant provides the product or service to the consumer for a successful transaction.

In an embodiment, the consumer notification may include a post-registration and payment option. The consumer receives the product or service from the merchant's site based on the micro-credit even though the consumer has not paid for the product or service. The consumer can perform post-registration and remit payment to the payment processor within a certain time period (e.g., 14 days).

FIGS. 4a-4d illustrate exemplary input windows for when a consumer selects a payment network transaction flow that utilizes consumer information from a network partner in accordance with one embodiment. The windows may be generated with rich client applications (e.g. Ajax, Flash, Java Script). A merchant can create its own customized payment page using APIs of the payment system.

FIG. 4a illustrates an exemplary input window 300 in accordance with one embodiment. The input window 300 (e.g., window 255) includes an input region 310 for entering a mobile phone number and a next option 320 for submitting the mobile phone number to the payment system 230. The payment system recognizes the mobile phone number as an initial input for a payment transaction and generates a OTP that is sent to a mobile device associated with the received mobile phone number.

FIG. 4b illustrates an exemplary input window 400 in accordance with one embodiment. The input window 400 includes a OTP input region 410 and a password input region 420 associated with the payment system that is displayed on the electronic device of the consumer at block 424. If this is a second or subsequent transaction for the consumer with the payment system 230, then the email address input region is replaced with authentication information such as a personal PIN or a third party password (e.g., Facebook password, Twitter password, OpenID password, etc.) input region. The window 400 also includes a re-send (OTP) SMS link 432, a continue checkout option 430 to submit the information entered into the regions 410 and 420. In an embodiment, a consumer can retry sending the OTP via SMS twice for a total of three attempts. If unsuccessful after three attempts, the consumer may contact consumer support.

The input window 400 also includes payment network network partner options 440 that utilize credential information associated with a network partner, which is a partner of the payment processor. Only approved network partners of the payment system 230 are listed as available options. If a consumer selects a network partner option (e.g., network partner option 1 (NP1), network partner option 2 (NP2), network partner option 3 (NP3), etc.), then credential fields (e.g., User ID input region 450, password input region 460) are dynamically generated and displayed on the window 400. The consumer enters the credential information for the selected network partner and selects the next option 470 to proceed with the payment transaction using a stored payment method of the selected network partner. The merchant site where a purchase is occurring may not be a network partner option for its own site. This particular merchant can only be a network partner for purchases from different merchants if this merchant is a network partner of the payment system 230.

Alternatively, the input window 400 is initially displayed with both the options 440 and the fields 450 and 460. A consumer selects one of the options 440 and enters the credential information into the fields 450 and 460.

FIG. 4c illustrates an exemplary input window 480 in accordance with one embodiment. The input window 480 is generated in response to receiving the consumer's credential information associated with a network partner from input window 400. Then, payment information from a network partner is provided to the payment system 230, which displays the input window 480 on the electronic device of the consumer to obtain authorization for charging the payment instrument stored with the payment merchant. The input window 480 includes payment information such as credit/debit card, an item or service name, a price for the item or service, and a submit option 482 to acknowledge and place the charge on the consumer's payment instrument (e.g., credit card, debit card, etc.).

FIG. 4D illustrates an exemplary transaction success window 490 in accordance with one embodiment. The window 490 is generated in response to selection of the submit option 482 of FIG. 4c. In an embodiment, the window 490 includes an indication that the consumer's payment transaction has been completed, an item or service name and a price. The window 490 may include a close window option 492.

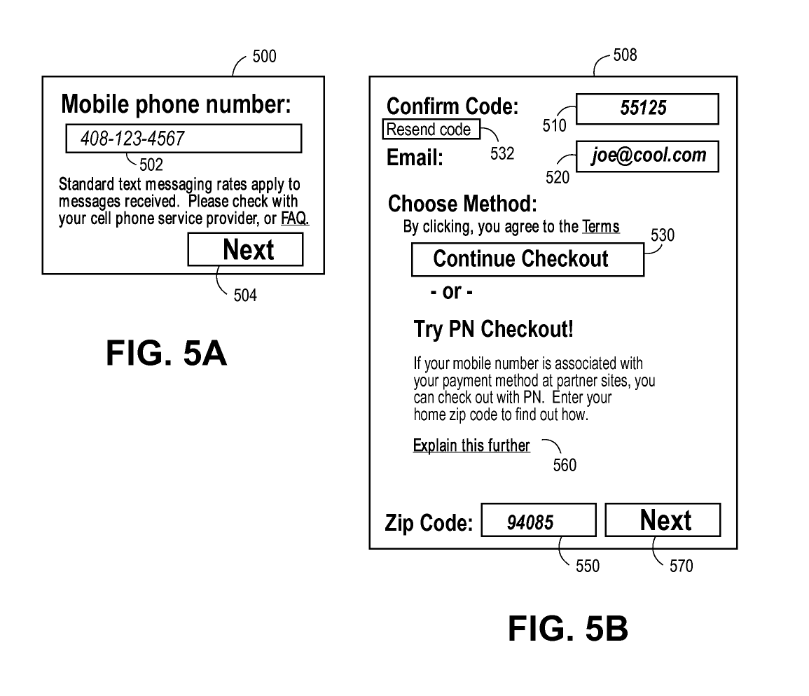

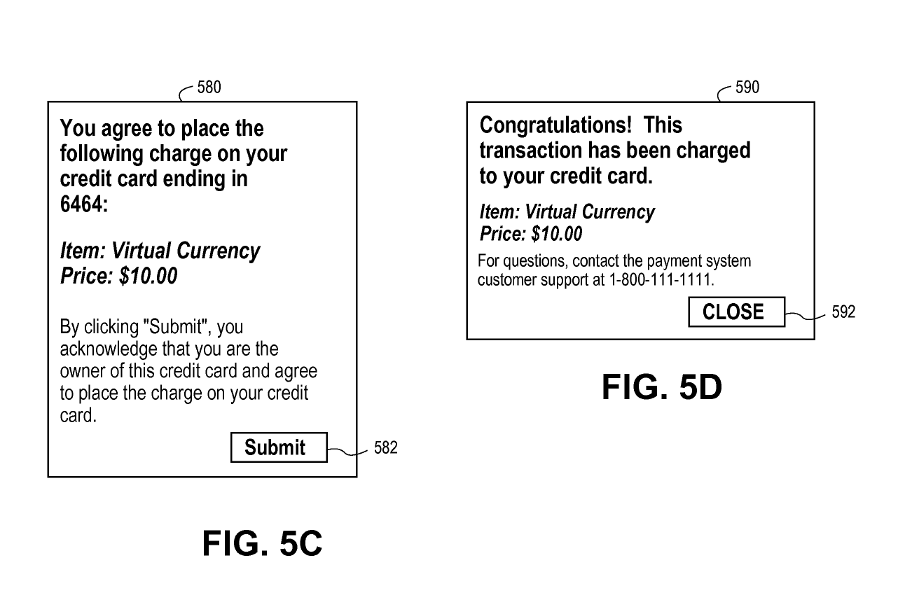

FIGS. 5a-5d illustrate exemplary input windows in accordance with an embodiment. FIGS. 5a-5d are similar to FIGS. 4a-d except that the consumer now enters a zip code in FIG. 5b instead of selecting a network partner in FIG. 4b. The input window 508 is generated in response to receiving a mobile phone number from input field 502 of input window 508 via the selection of next option 504. Then, the consumer enters the OTP and zip code. A network partner checks whether the zip code is associated with the received mobile phone number and account with the network partner.

The input window 508 includes a OTP input region 510 and a password input region 520 associated with the payment system that is displayed on the electronic device of the consumer. If this is a second or subsequent transaction for the consumer with the payment system 230, then the email address input region is replaced with authentication information such as a personal PIN or a third party password (e.g., Facebook password, Twitter password, OpenID password, etc.) input region. The window 508 also includes a re-send (OTP) SMS link 532, and a continue checkout option 530 to submit the information entered into the regions 510 and 520. In an embodiment, a consumer can retry sending the OTP via SMS twice for a total of three attempts. If unsuccessful after three attempts, the consumer may contact consumer support.

The input window 508 also includes payment network checkout that utilizes credential information associated with a network partner, which is a partner of the payment processor or payment system. The payment network checkout includes entering credential information into a credential field (e.g., zip code, other portion of address, other piece of consumer information stored with network partner). The consumer enters the credential information and selects the next option 570 to proceed with the payment transaction using a stored payment method of a network partner in a single operation. The payment network checkout also includes a link 560 to further explain the payment network checkout. The merchant site where a purchase is occurring may not be a network partner option for its own site. This particular merchant can only be a network partner for purchases from different merchants if this merchant is a partner of the payment system.

FIG. 5c illustrates an input window 580 that is generated in response to selection of the option 570 of FIG. 5b. The consumer confirms placing the payment charge on the payment method stored with the network partner and selects option 582. Then, an input window 590 is generated as illustrated in FIG. 5d. This window indicates that the transaction has been successfully charged to the payment method stored with the network partner.

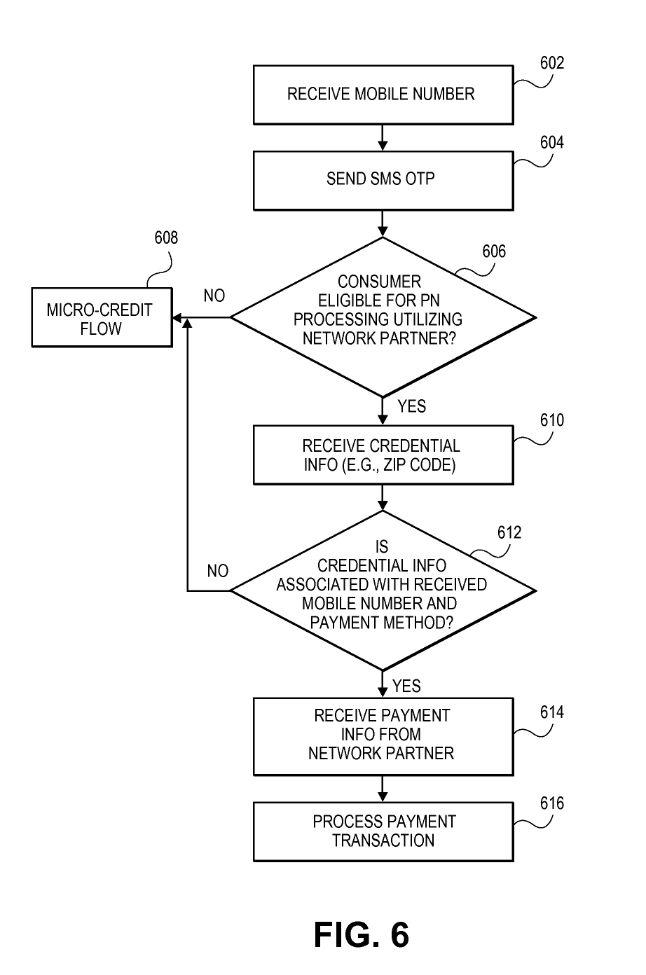

FIG. 6 illustrates a flow diagram of one embodiment for a method 600 of performing a payment transaction with a payment system that utilizes a network partner in accordance with an embodiment. The method 600 is performed by processing logic that may comprise hardware (circuitry, dedicated logic, etc.), software (such as is run on a general purpose computer system or a dedicated machine or a device), or a combination of both. In one embodiment, the method 600 is performed by processing logic of the payment processor or payment system or PN unit or combination of these components discussed herein. In an embodiment, the method 600 is associated with FIGS. 5A-5D.

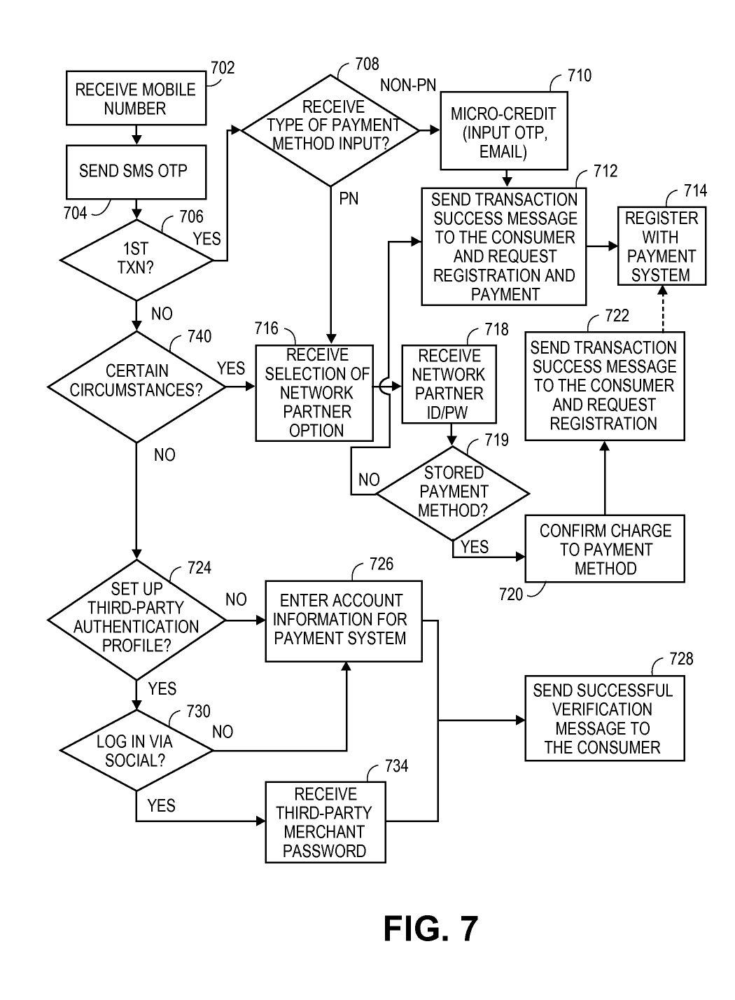

At block 602, the processing logic receives a mobile phone number from an input window displayed on an electronic device of the consumer. The processing logic sends a OTP to the consumer at block 604. At block 606, the processing logic of the payment system determines whether the consumer is eligible for payment network processing utilizing a network partner. In an embodiment, the consumer eligibility is determined based on the received mobile phone number. The processing logic determines whether the mobile phone number is stored in a network partner database and whether a valid payment method is attached to the mobile phone number. If not, then the processing logic proceeds with a micro-credit flow (e.g., operational blocks 710, 712, and 714 of FIG. 7) at block 608. For example, the processing logic may receive authentication information (e.g, OTP, email address) from the consumer and provide micro-credit as part of the micro-credit flow.

At block 610, if the consumer is eligible for payment network processing (e.g., the mobile phone number is stored in a network partner database and a valid payment method is attached to the mobile phone number), then the processing logic receives credential information (e.g., zip code, other portion of address, other piece of consumer information stored with network partner) from the consumer as illustrated in FIG. 5B. At block 612, the processing logic determines whether the received credential information (e.g., zip code, other portion of address, other piece of consumer information stored with network partner) is associated with the received mobile phone number and payment method. If not, then the processing logic proceeds with a micro-credit flow (e.g., operational blocks 710, 712, and 714 of FIG. 7) at block 608. If the received credential information (e.g., zip code, other portion of address, other piece of consumer information stored with network partner) is associated with the received mobile phone number and payment method of the network partner, then the processing logic receives payment information associated with the payment method from the network partner at block 614. The processing logic processes the payment transaction using the payment information received from the network partner at block 616.

FIG. 7 illustrates a flow diagram of one embodiment for a method 700 of performing a payment transaction with a payment system that utilizes a network partner. The method 700 is performed by processing logic that may comprise hardware (circuitry, dedicated logic, etc.), software (such as is run on a general purpose computer system or a dedicated machine or a device), or a combination of both. In one embodiment, the method 700 is performed by processing logic of the payment processor or payment system or PN unit or combination of these components discussed herein. In one embodiment, the method 700 is associated with FIGS. 4a-4d. At block 702, the processing logic receives a mobile phone number entered by the consumer into an input window displayed on an electronic device of the consumer. The processing logic sends a OTP to the consumer at block 704. At block 706, the processing logic of the payment system determines whether the consumer is transacting with the payment system for the first time based on the mobile phone number. If the consumer is transacting for the first time with the payment system, then the processing logic determines whether a type of payment method input is received at block 708. The consumer may input authentication information (e.g, OTP, email address) in order to receive micro-credit at block 710 as one type of a payment method input (e.g., non-payment network processing). At block 712, the processing logic sends a transaction success message via email and SMS to the consumer and requests registration with the payment system and payment for the purchase. At block 714, the consumer registers with the payment system.

Returning to block 708, if a PN payment method input is received, then the consumer selects a network partner option at block 716 in one embodiment. The processing logic of the payment system receives the consumer's account information (e.g., user ID, password) for the network partner from the consumer at block 718. If the network partner does not have a stored payment method at block 719, then the flow may proceed to block 712. If the network partner has a stored payment method for the consumer, then the flow proceeds to block 720.

At block 720, the processing logic confirms the payment charge using the payment method with the consumer. At block 722, the processing logic via email and SMS notifies the consumer of the payment transaction success and requests registration with the payment system. At block 714, the consumer registers with the payment system.

Returning to block 706, if the consumer has previously transacted with the payment system, then the processing logic for certain circumstances at block 740 may provide an input window with selectable network partner options and receive a selection of one of these options at block 716. The certain circumstances 740 may include a decision to direct more consumers to the network partners.

If the certain circumstances are not applicable at block 740, then the processing logic determines whether third party authentication has been established in the consumer's profile at block 724. If not, then the processing logic receives account information (e.g., password) for the payment system from the consumer at block 726. The processing logic via email and SMS sends the consumer a message indicating successful verification with the payment system at block 728.

Returning to block 724, if third party authentication is established, then the processing logic of the payment system determines whether the consumer wants to authenticate with a third party merchant via a third party method (e.g., Facebook method, Twitter method, OpenID method, etc.). If the consumer does not want to authenticate via a third party method, then the processing logic of the payment system generates an input window (for a second or subsequent transaction) with a OTP input region and a password input region associated with the payment system that is displayed on the electronic device of the consumer at block 424. If the consumer wants to authenticate via a third party method, then the processing logic of the payment system generates an input window (for a second or subsequent transaction) with a OTP input region that is displayed on the electronic device. The user input window also includes a password input region associated with the third party merchant (e.g., Facebook, Twitter, OpenID, etc.). The processing receives the third party merchant password at block 732. The flow returns to block 728.

FIG. 7 illustrates that a consumer can complete a payment transaction in different ways with different payment options. For example, for a first time transaction a consumer can receive micro-credit from the payment system to make a purchase without having any pre-registration. Alternatively, a consumer can select a network partner option and use a payment method stored with a network partner of the payment system. For a subsequent transaction with the payment system, a consumer can select a network partner option and use a payment method stored with a network partner of the payment system, authenticate directly with the payment system, or authenticate via a third party merchant.

These various payment options allow a consumer to quickly and easily complete payment transactions even with merchants that the consumer has no previous relationship or has no stored payment method. In this case, the consumer can use a payment method of the payment system or network partner that the consumer has already established a relationship and has confidence in the payment method of the network partner or payment system. Additionally, the consumer may not have to remember account credential information for the merchant. Instead, the consumer would only have to remember frequently used account credential information for the payment system or network partner.

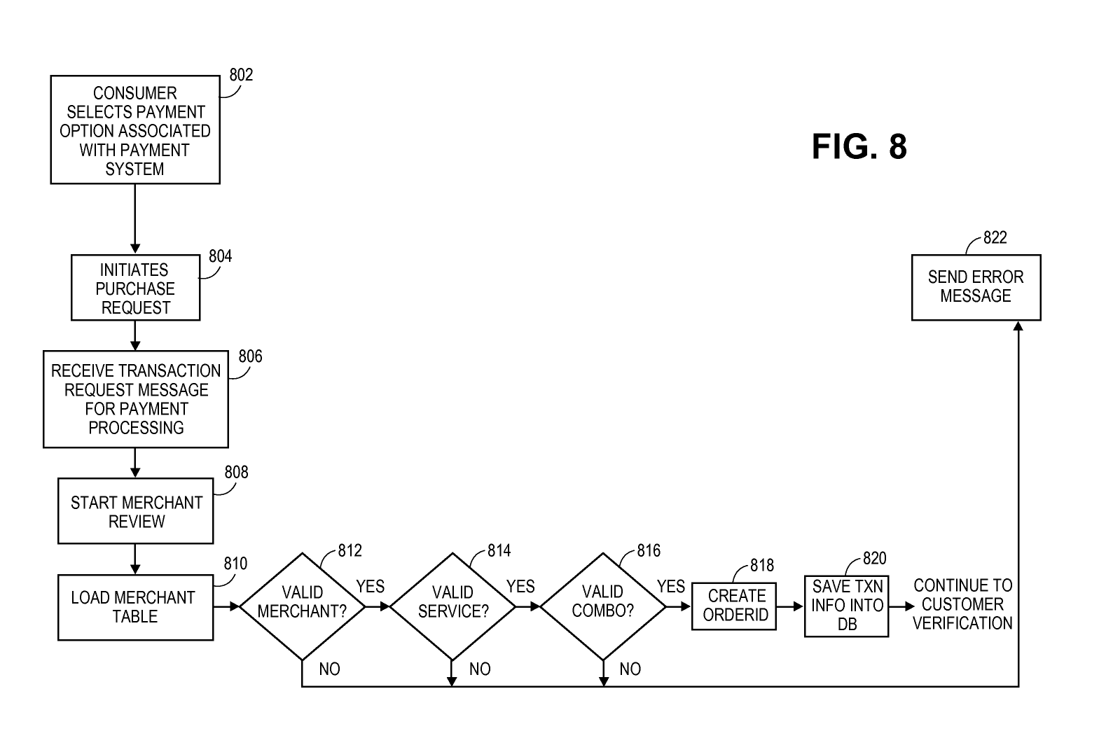

FIG. 8 illustrates a flow diagram of one embodiment for a method 800 of initializing a payment transaction with a payment system that utilizes a network partner. The method 800 is performed by processing logic that may comprise hardware (circuitry, dedicated logic, etc.), software (such as is run on a general purpose computer system or a dedicated machine or a device), or a combination of both. In one embodiment, the method 800 is performed by processing logic of the payment processor or payment system or PN unit or combination of these components discussed herein.

In an embodiment, the payment processor and/or payment system may be a machine within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a computer, a data processing system, a web appliance, a server, a network router, switch or bridge, data center, or any machine capable of executing a set of instructions (sequential or otherwise) that specify actions to be taken by that machine. Further, while only a single machine is illustrated, the term “machine” shall also be taken to include any collection of machines (e.g., servers, computers) that individually or jointly execute a set (or multiple sets) of instructions to perform any one or more of the methodologies discussed herein.

At block 802, a consumer initiates a purchase request from a merchant's site using an electronic device by selecting a payment option associated with the payment system. At block 804, the merchant initiates a purchase request. At block 806, the merchant generates a transaction request message and this message is received by the payment system. The transaction request message may include a merchant identifier, a merchant name, a service identifier, a service name, a sku identifier, a sku name, and a price. In one embodiment, the transaction request message is received via a communication protocol (e.g., http) and the message is encrypted by an advanced encryption standard (AES) algorithm. Communication between the payment system and the consumer uses secure HTTPS protocol. Standard HTTP is insecure and is subject to man-in-the-middle and eavesdropping attacks which can let attackers gain access to website accounts and sensitive information. HTTPS is designed to withstand such attacks and is considered secure (with the exception of older deprecated versions of SSL). Therefore, the processing logic encrypts the request message when initiating a transaction. The processing logic supports the encrypt request message creator from the merchant site.

At block 808, the processing logic starts the merchant review process. At block 810, the processing logic initializes a payment transaction by loading merchant information from a merchant management database (e.g., table). At blocks 812-816, the processing logic determines whether the received merchant information can be verified with registered merchant information of the payment system. In an embodiment, the merchant verification includes determining whether the merchant_id exists in the merchant management table at block 812, determining whether the merchant is available to service at block 814, and if the merchant_id and service_id match at block 816. If all three of the above conditions for determining verification successfully occur (e.g., merchant_id exists in the merchant management database, merchant is available to service, merchant_id matches service_id), then the merchant verification occurs successfully. A merchant may not be available if it has an expired or blocked status. A blocked status indicates that the merchant is disqualified. In an embodiment, a merchant provides more than one service (e.g., one merchant has multiple game services). The merchant may want each service managed separately.

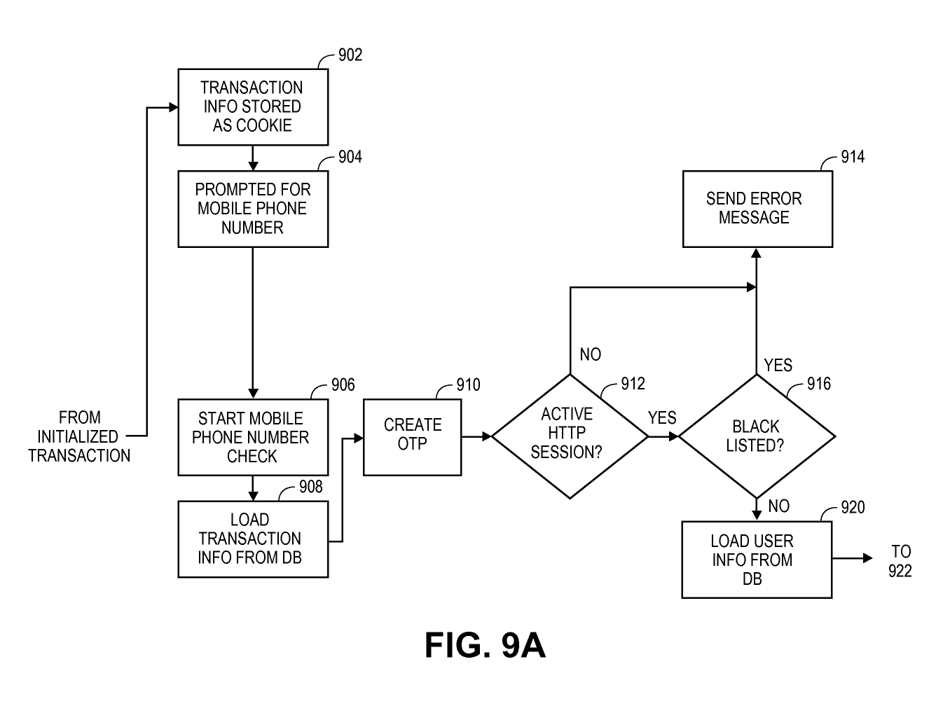

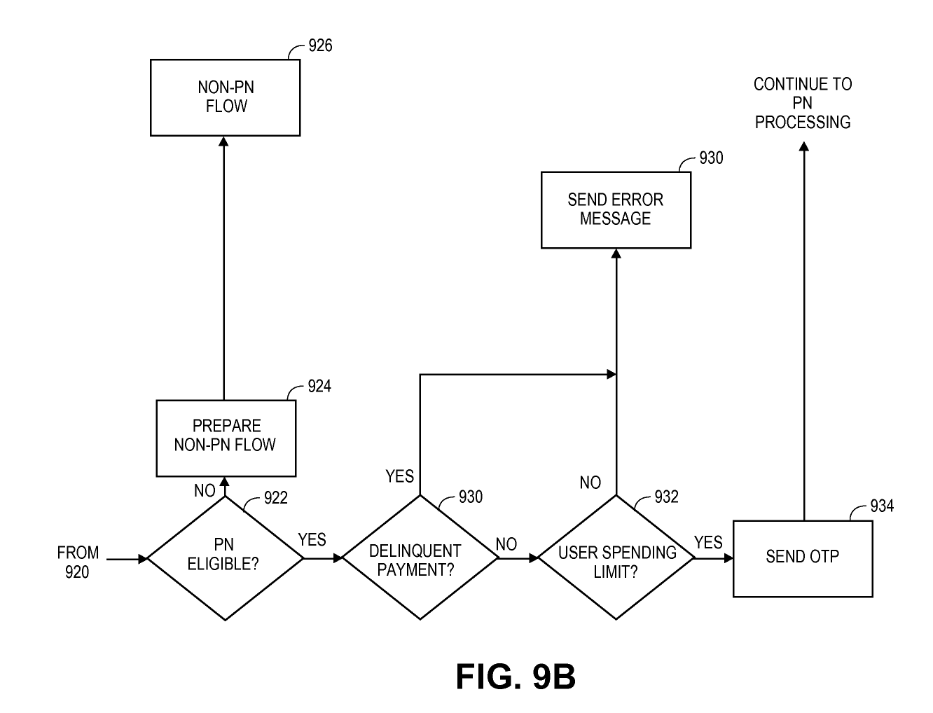

The transaction fails if any of the conditions fail (e.g., merchant_id does not match service_id). In this case, the received merchant information can not be verified with the registered merchant information. The payment system sends an error message to the merchant and optionally the consumer at block 822. Alternatively, if the transaction can be verified successfully, then the processing logic generates an order identification at block 818. The processing logic then saves the transaction information into a transaction database at block 820. Next, the flow continues to customer verification as illustrated in FIG. 9.

FIG. 9 illustrates a flow diagram of one embodiment for a method 900 of authenticating and verifying a consumer with a payment system. The method 900 is performed by processing logic that may comprise hardware (circuitry, dedicated logic, etc.), software (such as is run on a general purpose computer system or a dedicated machine or a device), or a combination of both. In one embodiment, the method 900 is performed by processing logic of the payment processor or payment system or PN unit or combination of these components discussed herein.

At block 902, the process continues from block 820 of FIG. 8 with transaction information being stored as a cookie. At block 904, an input window is displayed on an electronic device of the consumer and prompts the consumer for a mobile phone number. The payment system receives the mobile phone number entered by the consumer. At block 906, the processing logic initializes the verification of the received mobile phone number. At block 908, the processing logic of the payment system loads transaction information from a transaction database of the payment system. At block 910, the processing logic generates a OTP. At block 912, the processing logic determines whether an active HTTP session with the consumer has expired. In one embodiment, the session expires based on the expiration of a certain time period (e.g., 5 minutes from initiation of the transaction). At block 914, the transaction fails based on expiration of the session. The merchant and consumer receive an error message indicating the expired session. At block 916, if the session has not expired, then the processing logic determines whether the mobile phone number received from the consumer is black listed. At block 914, the transaction fails based on the mobile phone number being black listed. The merchant receives an error message indicating that the number has been black listed. At block 920, if the mobile phone number is not black listed (e.g., not found in a black list database), then the processing logic loads consumer information from a consumer database associated with the payment system.

At block 922, processing logic of the payment system determines whether the consumer is eligible to use the payment network (PN) that utilizes consumer information from a network partner. PN eligible consumers start a transaction at a merchant approved with the payment system, select the payment system at checkout as being the payment option, and have an account and payment instrument stored with a network partner. At block 924, for a PN ineligible consumer, processing logic of the payment system proceeds with operations for a non-PN flow (e.g., blocks 708 and 710 for a first time transaction; blocks 724, 726, 730, and 732 for a second time transaction). At block 926, the consumer receives non-PN flow operations.

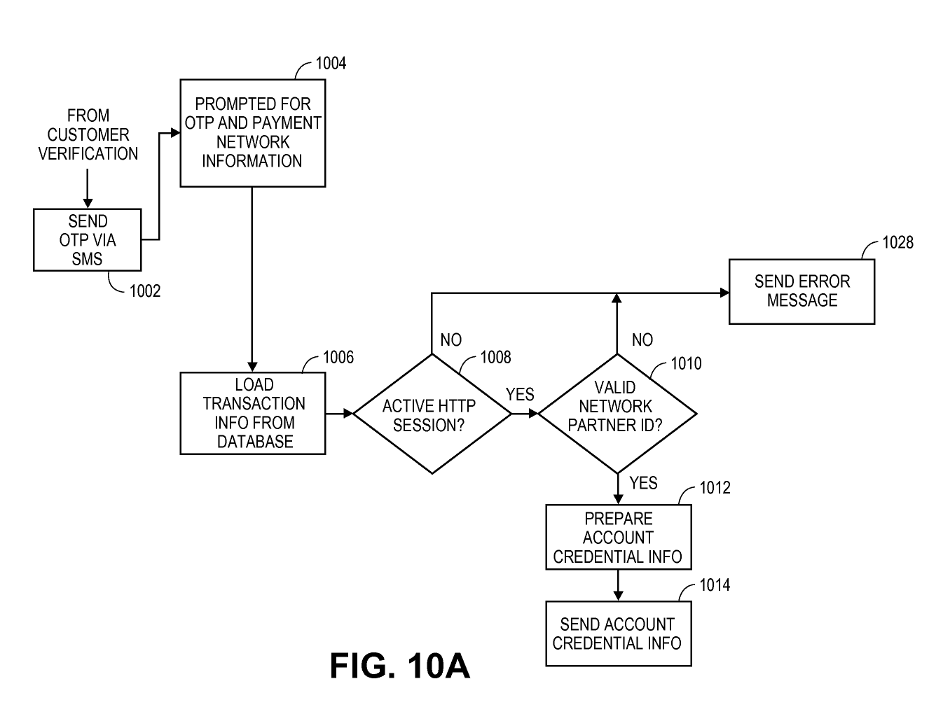

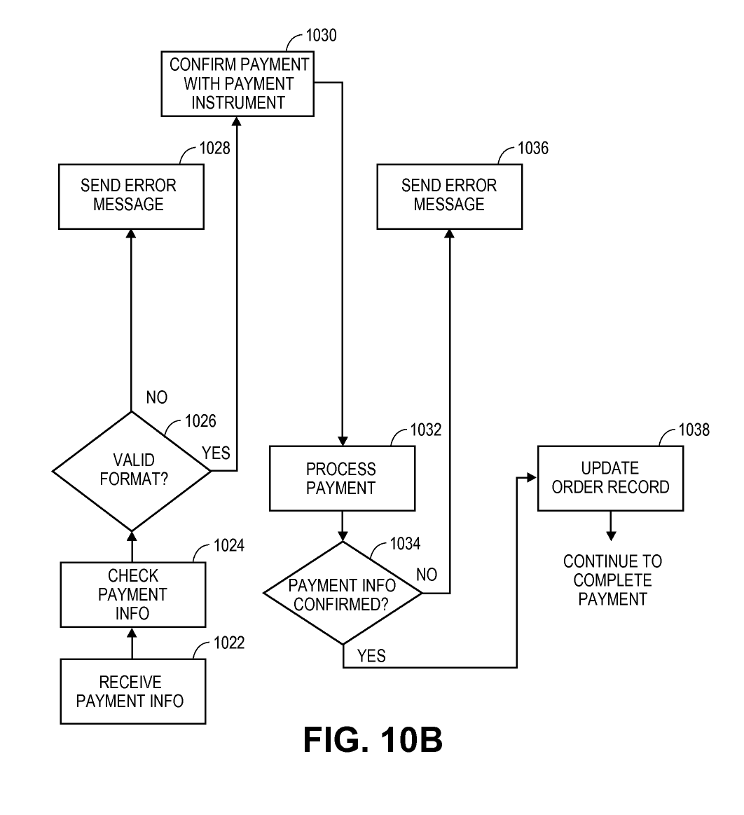

At block 928, for a PN eligible consumer, processing logic determines whether the consumer has any delinquent payments. If the consumer has delinquent payments, then the processing logic of the payment system notifies the merchant and consumer of transaction failure (i.e., send error message) at block 930. If the consumer has not delinquent payments, then the processing logic of the payment system performs a spending limit check at block 932. The payment system has a consumer spending limit policy based upon first or subsequent transaction and internal controlled limits. If the purchase price of a product or service is over the given limit per consumer, then the transaction fails. This means that if a monthly spending limit minus a stored virtual currency of the payment system that is purchased by the consumer minus a purchased SKU price is greater than zero, then the transaction fails. If the consumer exceeds the spending limit, then the processing logic of the payment system notifies the merchant and consumer of transaction failure (i.e., send error message) at block 930. If the consumer does not exceed the spending limit, then the processing logic sends the OTP to the consumer at block 934. The PN processing continues as illustrated in FIG. 10.

FIGS. 10A and 10B illustrate a flow diagram of one embodiment for a method 1000 of payment network processing. The method 1000 is performed by processing logic that may comprise hardware (circuitry, dedicated logic, etc.), software (such as is run on a general purpose computer system or a dedicated machine or a device), or a combination of both. In one embodiment, the method 1000 is performed by processing logic of the payment gateway or payment processor or payment system or PN unit or combination of these components discussed herein.

At block 1002, the flow continues from block 934 of FIG. 9 with the payment system sending the OTP to the consumer. The processing logic causes the electronic device of the consumer to display an input window that prompts the consumer for the OTP and PN information such as network partner name and account credential information (e.g., user ID, password) for the network partner at block 1004. The processing logic loads transaction information from a transaction database at block 1006.

At block 1008, the processing logic determines whether the HTTP session with the consumer is active. In one embodiment, the session expires based on expiration of a certain time period (e.g., 5 minutes from initiation of the transaction). At block 1028, an error message is sent to the merchant based on expiration of the session. The merchant and optionally the consumer receive notification of the expired session.

At block 1010, if the session is active and has not expired, then the processing logic determines whether a network partner identifier is valid. For example, the network partner may be assigned an identifier that needs to match an identifier for the network partner that is stored with the payment system. At block 1028, an error message is sent to the merchant if the network partner identifier is not valid. For this error condition, the process flow may proceed to block 710 of FIG. 7. At block 1012, if the network partner identifier is valid, then the processing logic prepares account credential information.

At block 1014, processing logic sends a message to a system of the network partner. The message includes a message identifier (e.g., 32 bit integer) to identify and associate each request with a corresponding reply. The message also includes account credential information of the consumer for authenticating with the network partner. The network partner system includes various systems and processing units for processing a transaction and sharing payment information under certain conditions.

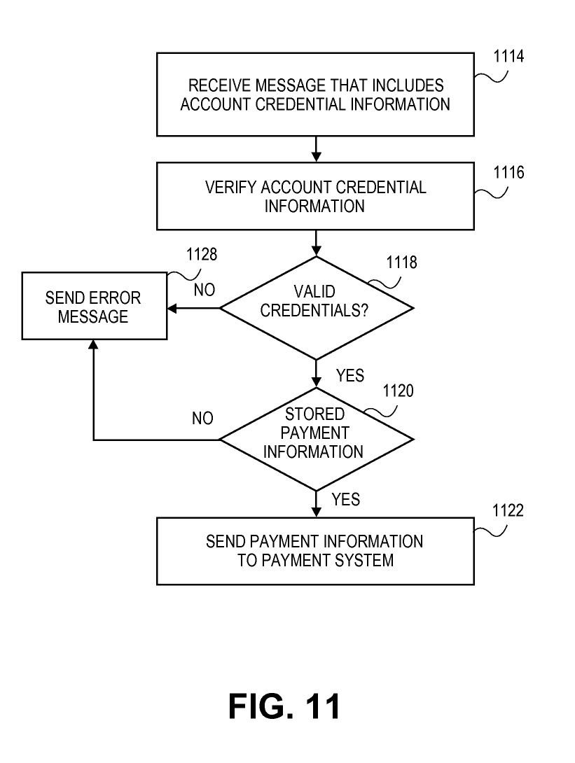

At block 1022 of FIG. 10B, if the network partner authenticates the consumer and has a stored payment instrument for the consumer as discussed in more detail below in conjunction with FIG. 11, then the processing logic receives the payment information from the system of the network partner. The payment information includes complete payment information (e.g., credit card or debit card information that includes the 16/15 digit card number, card expiration month and year, card verification value or card security code, cardholder name, cardholder address, cardholder phone number; etc.). The payment information may include bank account information (e.g., bank name, account type, routing number, account number, etc.) The processing logic has the option to either pass through or retain the payment information (e.g., credit card information, debit card information, bank account information) of the consumer received from the network partner.

At block 1024, the processing logic checks the payment information. In an embodiment, checking the payment information includes pre-verifying that the received payment information passes initial validation prior to processing the payment in real-time. For example, if the account type is a credit/debit card, then the processing logic verifies that the received month and year for the card's expiration date are not past the current date in order to determine whether the card is current and not expired. If the account type is a bank account, then the processing logic matches the bank details by account type, name, and account number with the bank institution to instantly confirm that the account exists prior to withdrawing money from the account.

At block 1026, the processing logic determines whether the payment information is received in a valid format. At block 1028, an error condition exists if the payment information is not received in a valid format (i.e., merchant receives error case) and an error message is sent to the merchant and consumer. For this error condition, the process flow may proceed to block 710 of FIG. 7.

At block 1030, if the payment information is received in a valid format, then the processing logic causes an input window to be generated on the electronic device of the consumer. The input window requests authorization for the payment using the payment instrument stored with the network partner. At block 1032, the processing logic processes payment with the payment instrument stored with the network partner. At block 1034, the processing logic determines whether the payment instrument and payment are confirmed by the consumer. At block 1036, an error message is sent to the merchant if the payment and payment instrument are not confirmed by the consumer. For this error condition, the process flow may proceed to block 710 of FIG. 7.

The processing logic processes the transaction for the amount initiated at the merchant site (e.g., first merchant) using the payment information provided by the network partner (e.g., second merchant). The processing logic internally verifies the information for formatting and basic validations before processing the transaction. Moreover, the consumer is clearly messaged and prompted to verify and authorize the information for processing. Any processing errors are messaged back to the merchant and displayed on the payment window of the electronic device of the consumer.

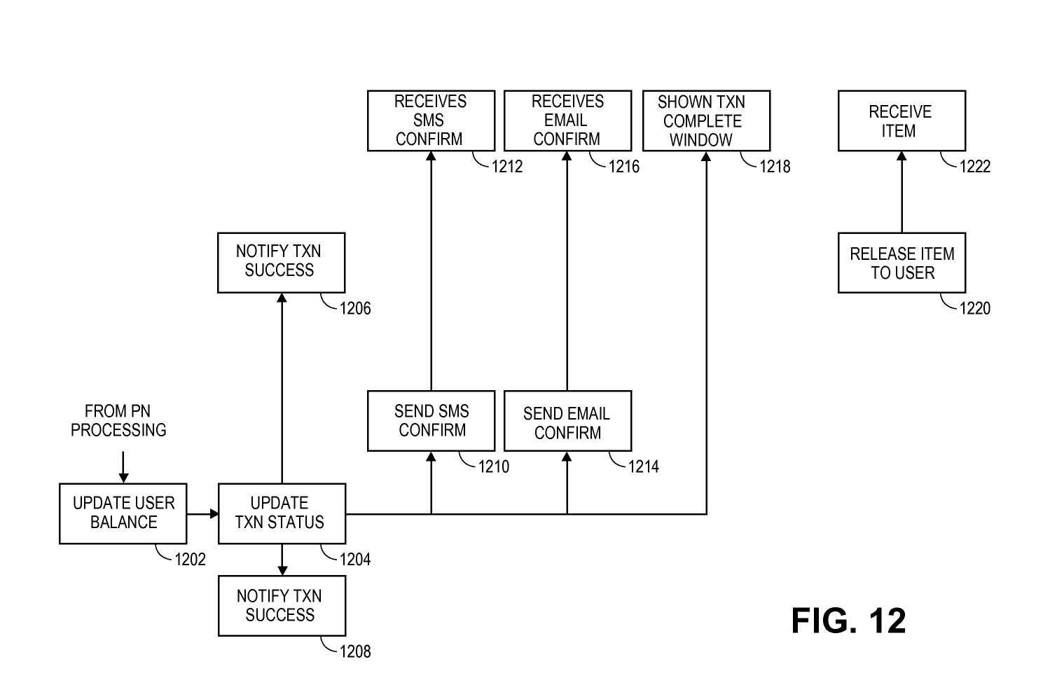

At block 1038, the processing logic updates an order record for the transaction. The process flow proceeds to completion of payment processing as illustrated in FIG. 12.

FIG. 11 illustrates a flow diagram of one embodiment for a method 1100 of sharing payment information for a payment transaction utilizing a network partner system. The method 1100 is performed by processing logic that may comprise hardware (circuitry, dedicated logic, etc.), software (such as is run on a general purpose computer system or a dedicated machine or a device), or a combination of both. In one embodiment, the method 1100 is performed by processing logic of the network partner system discussed herein.

The network partner system includes various systems and processing units for processing a transaction. The system may include an authenticating unit for authenticating a consumer based on account credential information (e.g., user ID, password). The system may also include a payment unit for processing consumer transactions. The system may include databases for storing account information and payment information (e.g., credit card, debit card, bank account, etc.).

At block 1114, the process flow continues from block 1014 of FIG. 10 with the network partner receiving a message that indicates a payment transaction between a consumer and a merchant from the payment system. The message includes a message identifier and account credential information of a consumer for authenticating with the network partner.

At block 1116, the network partner verifies the account credential information with the system. At block 1118, the network partner determines whether the account credential information received from the consumer is valid and successfully authenticated with the system. At block 1128, an error message is sent to the merchant if the account information is not valid. At block 1120, if the account credential information is valid, then the network partner determines whether the consumer has a payment instrument (e.g., credit card, debit card, bank account, etc.) stored with the network partner. At block 1128, an error message is sent to the merchant if no payment information is stored with the network partner. For this error condition, the process flow may proceed to block 710 of FIG. 7. At block 1120, the payment information is sent from the network partner system to the payment system if the payment information is stored with the network partner. The process flow then continues with block 1022 of FIG. 10.

FIG. 12 illustrates a flow diagram of one embodiment for a method 1200 of completing a payment transaction. The method 1200 is performed by processing logic that may comprise hardware (circuitry, dedicated logic, etc.), software (such as is run on a general purpose computer system or a dedicated machine or a device), or a combination of both. In one embodiment, the method 1200 is performed by processing logic of the payment processor or payment system or PN unit or combination of these components discussed herein.

At block 1202, the process flow continues from block 1038 of FIG. 10 with the processing logic of the payment system updating the consumer's balance after making payment for the transaction. At block 1204, the processing logic updates transaction status for the transaction including a transaction record and payment details related to the PN processing.

Then, the processing logic sends a notification of transaction success to the merchant and the network partner at blocks 1206 and 1208, respectively. The network partner receives a separate line item that lists out PN based transactions conducted successfully during an invoice period. The merchant receives a merchant invoice for all transactions whether PN transactions or non-PN transactions with the payment system. The processing logic sends a transaction success message via email and also via SMS to the mobile device of the consumer at blocks 1210 and 1214, respectively. At blocks 1212 and 1216, the consumer receives the transaction success message via email and also via SMS to the mobile device. The processing logic causes the electronic device to display the transaction complete window at block 1218.

At block 1220, the merchant releases the product or service to the consumer. At block 1222, the consumer receives the product or service from the merchant.

FIG. 13 illustrates a system overview for a payment transaction with a payment system that utilizes payment information provided by a network partner in accordance with certain embodiments. The system 1300 allows a consumer 1322 (e.g., customer), a merchant 1342, a network partner system 1360, and a payment system 1310 to interact to process a payment transaction. A consumer 1322 using an electronic device 1326 generates a purchase transaction 1324. The consumer manages payment features 1328 (e.g., payment method management, payment, transaction inquiry, balance management, and dispute (cancellation)) using the electronic device 1326 that accesses a consumer site 1320. A payment system 1310 includes processing system 1309 and data storage device 1308. The processing system 1309 implements core management and control systems. The data storage device 1308 may include a machine-accessible storage medium 1307 on which is stored one or more sets of instructions (e.g., software) embodying any one or more of the methodologies or functions described herein. The software may also reside, completely or at least partially, within the processing system 1309 during execution thereof by the processing system 1309, the processing system 1309 also constituting machine-accessible storage media.

The machine-accessible storage medium 1307 may also be used to store data structure sets (e.g., databases) that store consumer, merchant, transaction, and payment system information as discussed herein. While the machine-accessible storage medium 1307 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instructions for execution by the machine and that cause the machine to perform any one or more of the methodologies of the present invention. The term “machine-accessible storage medium” shall accordingly be taken to include, but not be limited to, solid-state memories, optical, and magnetic media.

The payment system 1310 communicates with a transaction server 1312, a consumer site 1320, a CRM module 1330, a merchant site 1340, and the network partner system 1360. A merchant 1342 provides goods or services and generates a purchase transaction 1344. A merchant person in charges 1346 manages features 1348 (e.g., settlement, transaction inquiry, transaction statistic, dispute (cancellation), reports, etc.) and communicates with the merchant site 1340. A payment system person in charge 1332 manages payment system features and systems 1334 (e.g., access control list management, billing, dispute management, fraud rule/blacklist management, collection management, reports, etc) and communicates with the CRM site 1330.

A network partner system 1360 includes an authentication unit 1362, a payment unit 1364, and databases 1366 for authenticating account credentials provided by the payment system 1332. If the account credentials are authenticated, then the network partner system 1360 provides payment information for the consumer to the payment system for processing of the payment transaction.

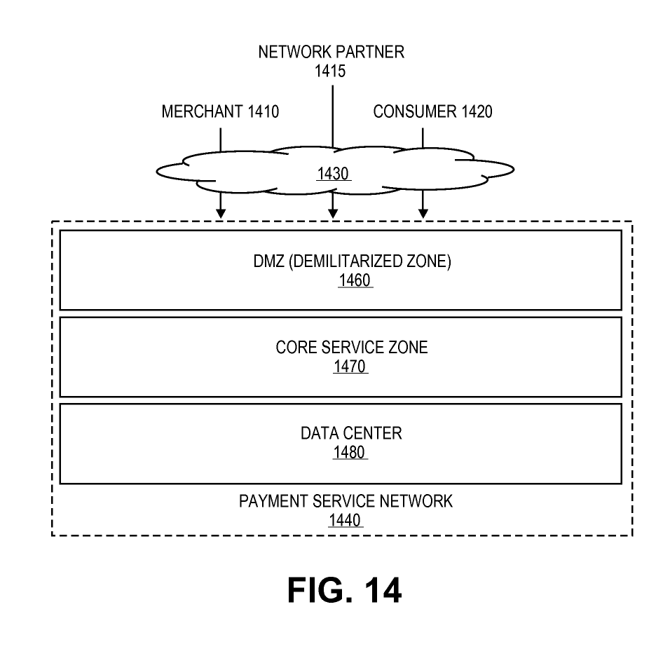

FIG. 14 illustrates a network topology for a payment transaction with a payment system that utilizes a network partner in accordance with certain embodiments. A network topology 1400 includes a merchant 1410, a network partner 1415, a consumer 1420, a communication network 1430 (e.g., Internet), and a payment service network 1440 associated with the payment system. The network 1440 includes a demilitarized zone (DMZ) 1460 (e.g., public network to expose external service), a core service zone 1470 (e.g., private network for internal core service—campus network), and a data center 1480, which is a strongly secured network for databases.

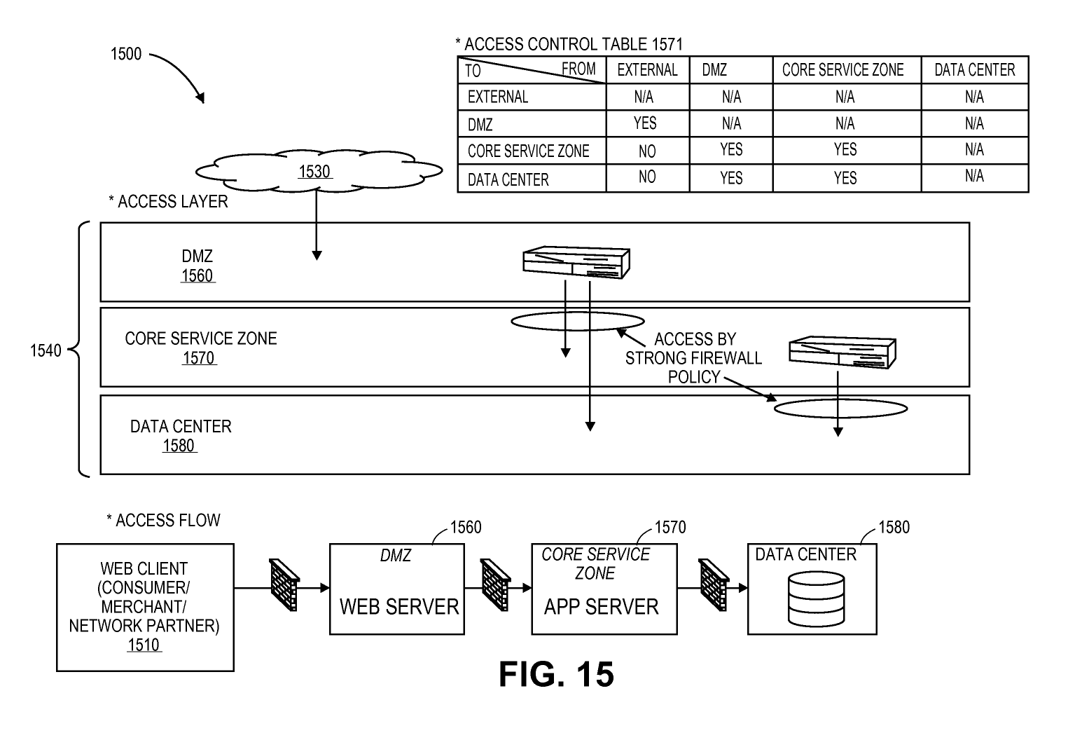

FIG. 15 illustrates a network topology for a payment transaction with a payment system that utilizes a network partner in accordance with another embodiment. A network topology 1500 for a payment system includes a web client 1510 (e.g., consumer, merchant, network partner), a communication network 1530 (e.g., Internet), and a payment service network 1540. The network 1540 includes a demilitarized zone 1560 implemented with web server(s), a core service zone 1570 implemented with application server(s), and a data center 1580 implemented with databases. An access control table 1571 shows the accessibility between different layers.

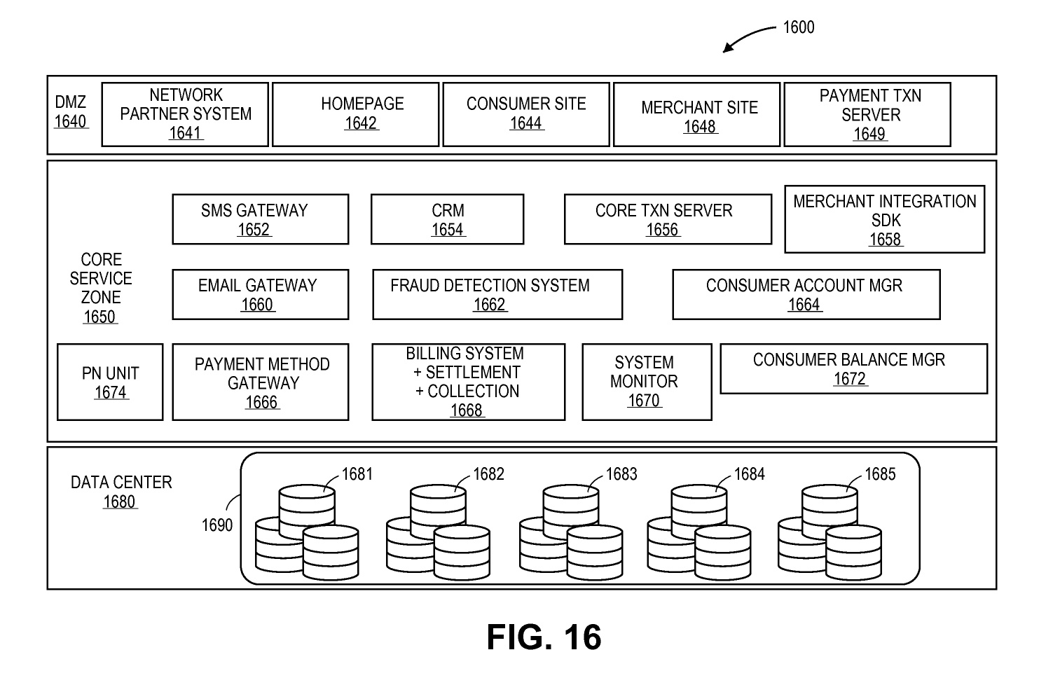

FIG. 16 illustrates a payment system for a payment transaction that utilizes payment information from a network partner system in accordance with one embodiment. The payment system 1600 is associated with a DMZ 1640, a core service zone 1650, and a data center 1680. The payment system 1600 may be implemented as part of a collocation center model where multiple consumers and merchants locate network, server and storage gear and interconnect to a variety of telecommunications and other network service provider(s) with a minimum of cost and complexity. For example, the payment system 1600 includes or communicates with a network partner system 1641, a payment system site (e.g., home page) 1642, a consumer site 1644, a merchant site 1648, and a payment transaction server 1649. In an embodiment, the payment system 1600 does not include the network partner 1641, the merchant site 2848, and the consumer site 2844. The payment system 1600 includes or communicates with a payment network unit 1674, a SMS gateway 1652, a CRM module 1654, a core transaction server 1656, a merchant integration software design kit 1658, an email gateway 1660, a fraud detection system 1662, a consumer account manager 1664, a payment method gateway 1666, a billing system 1668, a system monitor 1670, and a consumer balance manager 1672. The data center 1680 includes databases 1681-1685.

In an embodiment, the components (e.g., payment network unit 1674, payment transaction server 1649, CRM 1654, fraud detection system 1662, databases 1681-1685, etc.) may include or may be stored on a machine-accessible storage medium. For example, the payment network unit 1674 may include a single medium or multiple media (e.g., a centralized or distributed database, and/or associated caches and servers) that store the one or more sets of instructions associated with the payment network unit 1674. The data center 1680 may include a machine-accessible storage medium 1690 that is used to store data structure sets (e.g., databases 1681-1685) that store consumer, merchant, network partner, transaction, and payment system information as discussed herein.

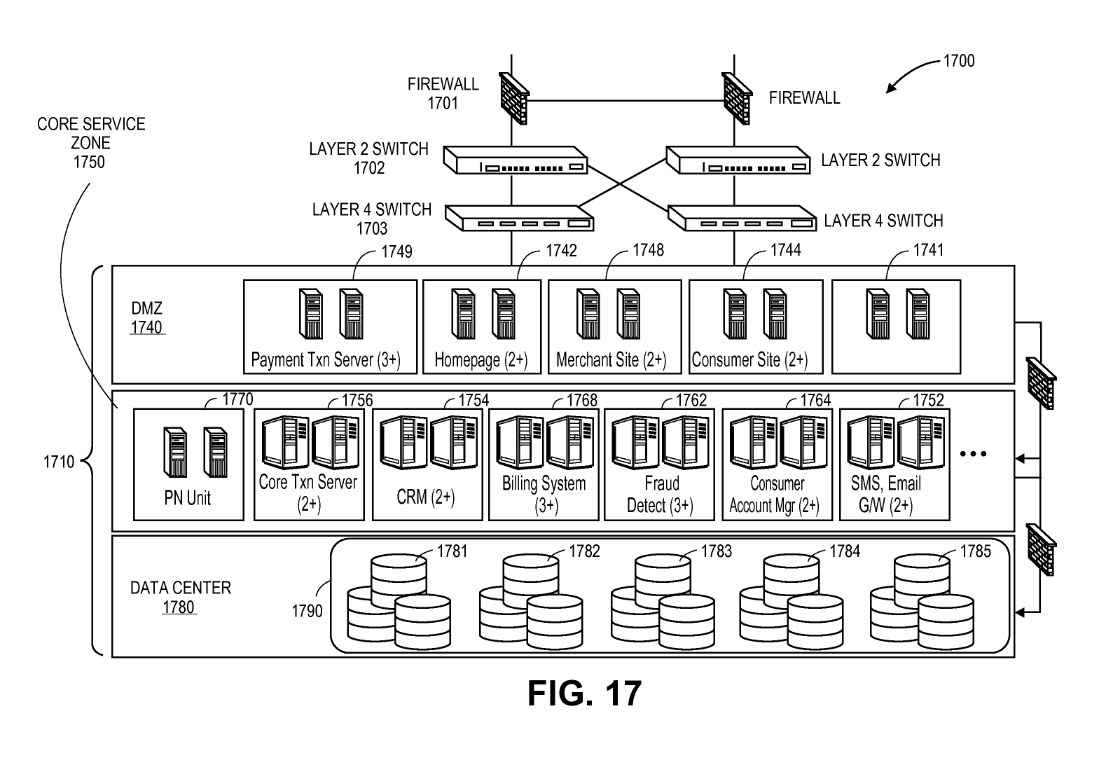

FIG. 17 illustrates a network topology for a payment transaction with a payment system that utilizes payment information provided by a network partner system in accordance with another embodiment. The network topology 1700 includes firewalls 1701, layer 2 switches 1702, layer 4 switches 1703, a DMZ 1740, a core service zone 1750, and a data center 1780. The payment system 1710 may be implemented as part of a collocation center model. For example, the payment system 1710 includes or communicates with a network partner system 1741, a payment system site (e.g., website home page) 1742, a consumer site 1744, a merchant site 1748, and a payment transaction server 1749. In an embodiment, the payment system 1710 does not include the network partner system 1741, merchant site 1748, and the consumer site 1744. The payment system 170 includes or communicates with a payment network unit 1770, a SMS/email gateways 1752, a CRM module 1754, core transaction servers 1756, a fraud detection system 1762, a billing system 1768, etc. The data center 1780 includes databases 1781-1785.

In an embodiment, the components (e.g., payment network unit 1770, payment transaction server 1749, CRM 1754, fraud detection system 1762, databases 1781-1785, etc.) may include or may be stored on a machine-accessible storage medium. For example, the payment network unit 1770 may include a single medium or multiple media (e.g., a centralized or distributed database, and/or associated caches and servers) that store the one or more sets of instructions associated with the fraud detection system. The data center 1780 may include a machine-accessible storage medium 1790 that is used to store data structure sets (e.g., databases 1781-1785) that store consumer, network partner, merchant, transaction, and payment system information as discussed herein.

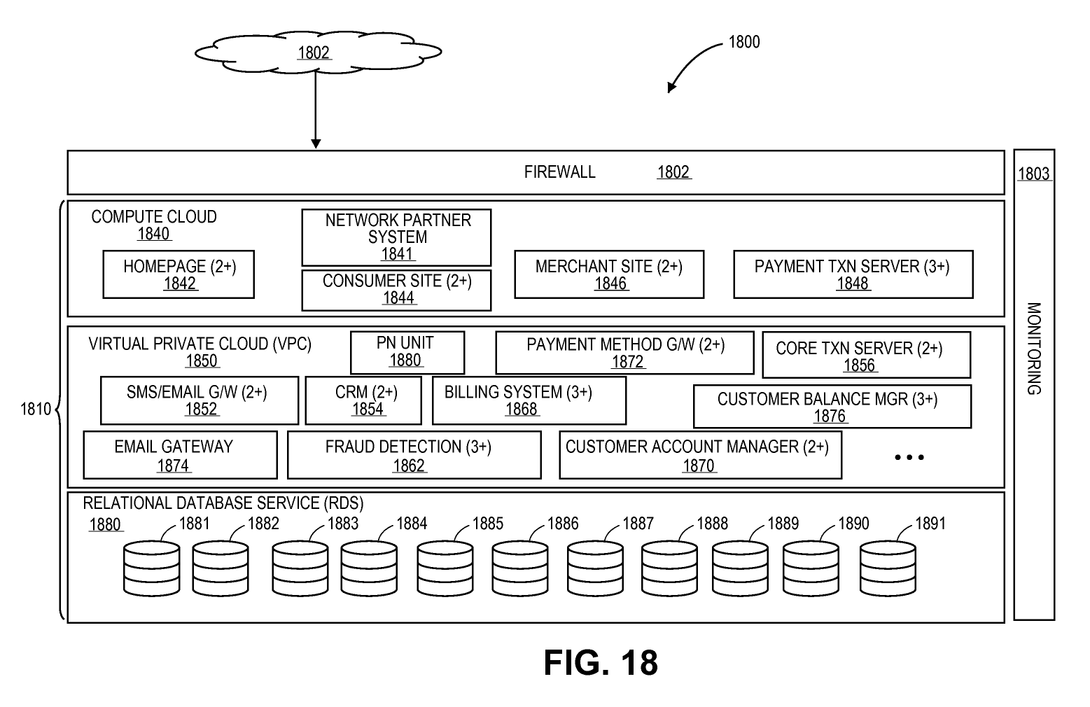

FIG. 18 illustrates a network topology for a payment transaction with a cloud service model and payment system that utilizes a network partner system in accordance with another embodiment. The cloud service model is Internet-based computing in which shared resources, software, and information are provided to computers and other devices on-demand. The cloud service model can be provided by various services providers (e.g., Amazon.com®, Google®, Microsoft®). In an embodiment, Amazon Elastic Compute Cloud (Amazon EC2) Environment is the cloud service model.

The network topology 1800 couples to a communication network (e.g., Internet) 1802 and includes a firewall (e.g., EC2 load balancing and security layer) 1802, a monitoring module (e.g., Amazon EC2 cloudwatch) 1803, and a payment system 1810. The payment system 1810 includes a compute cloud 1840 (e.g., Amazon EC2), a virtual private cloud (VPC) 1850, and a relational database service 1880 that includes databases 2881-1891.

The compute cloud 1840 includes or communicates with a network partner system 1841, a payment system site (e.g., website home page) 1842, a consumer site 1844, a merchant site 1848, and payment transaction servers 1849. In an embodiment, the payment system 1810 does not include the network partner system 1841, merchant site 1848 and the consumer site 1844. The VPC (e.g., Amazon VPC) 1850 includes or communicates with a payment network unit 1880, a SMS/email gateways 1852, a CRM module 1854, core transaction servers 1856, a fraud detection system 1862, a billing system 1868, a consumer account manager 1870, payment method gateways 1872, an email gateway 1874, a consumer balance manager 1876, etc.

In an embodiment, the components (e.g., payment network unit 1870, payment transaction server 1848, CRM 1854, fraud detection system 1862, databases 1881-1891, etc.) may include or may be stored on a machine-accessible storage medium. For example, the payment network unit 1870 may include a single medium or multiple media (e.g., a centralized or distributed database, and/or associated caches and servers) that store the one or more sets of instructions associated with the payment network processing. The data center 1880 may include a machine-accessible storage medium that is used to store data structure sets (e.g., databases 1881-1891) that store consumer, network partner, merchant, transaction, and payment system information as discussed herein.

In certain embodiments, a payment system (e.g., 1610, 1710, 1810) processes a payment transaction utilizing a network partner system. The payment system includes at least one web server (e.g., payment transaction server) to receive a payment transaction request, a payment network unit (e.g., one or more servers, one or more gateways, combination of servers and gateways, etc.) to provide payment services between a consumer and a merchant based on payment information provided by a network partner, and a data center to store transaction information, consumer information, network partner information, and merchant information associated with the payment transaction.

In one embodiment, a consumer with an electronic device (e.g., mobile device, computing device, computer, laptop, tablet, netbook, hand-held device, etc.) shops for a product (e.g., item, content) or service from an online merchant's site and selects a payment option to purchase the product or service. A payment transaction server (e.g., server 1649, server 1749, server 1849) receives a payment transaction request from an online merchant. The payment transaction server sends a verify merchant information request that includes merchant information to a core transaction server (e.g., server 1656, server 1756, server 1856). The core transaction server loads merchant information from a merchant database of the database systems and verifies the merchant information. The payment transaction server generates and saves transaction information in a transaction management database to complete initiation of a transaction.

Next, for consumer verification, the payment transaction server receives a mobile phone number from the consumer. The payment transaction server interacts with the fraud detection system, customer account module, and databases to verify customer information. The payment transaction server generates a OTP and sends it via a SMS gateway to the mobile device of the consumer. The payment transaction server then may receive the OTP and additional authentication information (e.g., authentication information for authenticating with the payment system, authentication information for authenticating with a third party merchant) from the consumer. The core transaction server performs customer authentication by loading transaction and customer information from databases and verifying the OTP and additional authentication information.

Alternatively, the consumer may select from selectable network partner options displayed on the electronic device of the consumer in response to initiating the payment transaction. The payment network unit (e.g., 1674, 1770, 1880) provides the selectable network partner options. The payment network unit receives a selection of one of the network partner options. The payment network unit generates an authentication region to be displayed on the electronic device in order to receive the consumer's account credential information in response to the selection of the network partner option. Subsequently, the payment network unit receives account credential information for the selected network partner from the consumer. The payment network unit sends the account credential information to the network partner for authentication. The network partners associated with the network partner options each partner with the payment system. The payment network unit receives payment information for the consumer from the network partner if the consumer is authenticated with the network partner. Then, the payment system processes the payment transaction on behalf of the merchant.

In some embodiments, a network partner system (e.g., 1360, 1641, 1741, and 1841) includes an authentication unit (e.g., 1342) to receive a message from the payment system. The message includes account credential information of the consumer for authenticating with the network partner. The authentication unit determines whether the account credential information is successfully authenticated with the authentication unit. The network partner system also includes a payment unit (e.g., 1344) that is coupled to the authentication unit. The payment unit determines whether payment information for the consumer is stored in the network partner system if the account credential information is successfully authenticated. The payment unit sends an error message to the payment system if the account credential information is successfully authenticated and payment information is not stored in the system of the network partner.

The payment unit sends the payment information to the payment system if the account credential information is successfully authenticated and payment information is stored in the system of the network partner. The network partner with the payment system for processing the payment transaction on behalf of the merchant.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method of processing a payment transaction between a consumer and a merchant, the method comprising:
initiating, with a payment system, the payment transaction between the consumer and the merchant;
generating, with the payment system, a plurality of selectable network partner options to be displayed on an electronic device of the consumer in response to initiating the payment transaction, the network partners each partner with the payment system;
receiving, with the payment system, a selection of one of the network partner options and account credential information for the selected network partner from the consumer; and
sending the account credential information, with the payment system, to the network partner for authentication.

2. The method of claim 1, further comprises:
receiving payment information, with the payment system, for the consumer from the network partner; and
processing the payment transaction, with the payment system, on behalf of the merchant.

3. The method of claim 1, further comprises:
generating an authentication region to be displayed on the electronic device to receive the consumer's account credential information in response to the selection of the network partner option.

4. The method of claim 3, wherein the account credential information comprises a user ID and password of the consumer that is sent to the network partner for authenticating the consumer with the network partner.

5. The method of claim 1, further comprises:
sending a confirmation message, with the payment system, to the consumer to confirm that the consumer authorized a payment to the merchant using the payment information provided by the network partner.

6. The method of claim 1, wherein initiating the payment transaction further comprises:
receiving, with the payment system, a payment transaction request that indicates a payment transaction between a merchant's site and the consumer using the electronic device of the consumer;
generating, with the payment system, a mobile phone number input form that is displayed on the electronic device of the consumer in response to receiving the payment transaction request.
receiving, with the payment system, a mobile phone number associated with a mobile device of the consumer; and
generating and sending to the mobile device, with the payment system, a one time passcode (OTP) in response to receiving the mobile phone number from the consumer.

7. A machine-accessible storage medium including data that, when accessed by a machine, cause the machine to perform a method of processing a payment transaction between a consumer and a merchant, the method comprising:
initiating, with a payment system, the payment transaction between the consumer and the merchant;
generating, with the payment system, a plurality of selectable network partner options to be displayed on an electronic device of the consumer in response to initiating the payment transaction, the network partners each partner with the payment system;
receiving, with the payment system, a selection of one of the network partner options and account credential information for the selected network partner from the consumer; and
sending the account credential information, with the payment system, to the network partner for authentication.

8. The machine-accessible storage medium of claim 7, the method further comprises:
receiving payment information, with the payment system, for the consumer from the network partner; and
processing the payment transaction, with the payment system, on behalf of the merchant.

9. The machine-accessible storage medium of claim 7, the method further comprises:
generating an authentication region to be displayed on the electronic device to receive the consumer's account credential information in response to the selection of the network partner option.

10. The machine-accessible storage medium of claim 9, wherein the account credential information comprises a user ID and password of the consumer that is sent to the network partner for authenticating the consumer with the network partner.

11. The machine-accessible storage medium of claim 7, the method further comprises:
sending a confirmation message, with the payment system, to the consumer to confirm that the consumer authorized a payment to the merchant using the payment information provided by the network partner.

12. The machine-accessible storage medium of claim 7, wherein initiating the payment transaction further comprises:
receiving, with the payment system, a payment transaction request that indicates a payment transaction between a merchant's site and the consumer using the electronic device of the consumer;
generating, with the payment system, a mobile phone number input form that is displayed on the electronic device of the consumer in response to receiving the payment transaction request.
receiving, with the payment system, a mobile phone number associated with a mobile device of the consumer; and
generating and sending to the mobile device, with the payment system, a one time passcode (OTP) in response to receiving the mobile phone number from the consumer.

13. A payment system to process a payment transaction, the payment system comprising:
at least one web server to receive a payment transaction request to initiate a payment transaction between a consumer and a merchant; and
a payment network unit coupled to the at least one web server, the payment network unit to generate a plurality of selectable network partner options to be displayed on an electronic device of the consumer in response to initiating the payment transaction, to receive a selection of one of the network partner options and account credential information for the selected network partner from the consumer, and to send the account credential information to the network partner for authentication, the network partners each partner with the payment system.

14. The payment system of claim 13, wherein the payment network unit to receive payment information for the consumer from the network partner and to process the payment transaction on behalf of the merchant.

15. The payment system of claim 13, wherein the payment network unit to generate an authentication region to be displayed on the electronic device in order to receive the consumer's account credential information in response to the selection of the network partner option.

16. A method of sharing payment information for a payment transaction, the method comprising:
receiving, with a system of a network partner, a message that includes account credential information of a consumer for authenticating with the network partner, the message being received from a payment system that processes the payment transaction between the consumer and a merchant;
determining whether the account credential information is successfully authenticated with the system of the network partner;
determining whether payment information for the consumer is stored with the system of the network partner if the account credential information is successfully authenticated, the network partner partners with the payment system for processing the payment transaction on behalf of the merchant; and
sending the payment information from the system of the network partner to the payment system if the account credential information is successfully authenticated and payment information is stored in the system of the network partner.

17. The method of claim 16, further comprises:
sending, with the system of the network partner, an error message to the payment system if the authentication fails.

18. The method of claim 16, further comprises:
sending an error message to the payment system if the account credential information is successfully authenticated and payment information is not stored in the system of the network partner.

19. A machine-accessible storage medium including data that, when accessed by a machine, cause the machine to perform a method of sharing payment information for a payment transaction, the method comprising:
receiving, with a system of a network partner, a message that includes account credential information of a consumer for authenticating with the network partner, the message being received from a payment system that processes the payment transaction between the consumer and a merchant;
determining whether the account credential information is successfully authenticated with the system of the network partner;
determining whether payment information for the consumer is stored with the system of the network partner if the account credential information is successfully authenticated, the network partner partners with the payment system for processing the payment transaction on behalf of the merchant; and
sending the payment information from the system of the network partner to the payment system if the account credential information is successfully authenticated and payment information is stored in the system of the network partner.

20. The machine-accessible storage medium of claim 19, further comprises:
sending, with the system of the network partner, an error message to the payment system if the authentication fails.

21. The machine-accessible storage medium of claim 19, further comprises:
sending an error message to the payment system if the account credential information is successfully authenticated and payment information is not stored in the system of the network partner.

22. A system, comprising:
an authentication unit to receive a message that includes account credential information of a consumer for authenticating with the network partner, the message being received from a payment system that processes the payment transaction between the consumer and a merchant, the authentication unit to determine whether the account credential information is successfully authenticated with the authentication unit; and
a payment unit coupled to the authentication unit, the payment unit to determine whether payment information for the consumer is stored in the system of the network partner if the account credential information is successfully authenticated, the network partner partners with a payment system for processing the payment transaction on behalf of the merchant.

23. The system of claim 22, wherein the payment unit to send an error message to the payment system if the account credential information is successfully authenticated and payment information is not stored in the system of the network partner.

24. The system of claim 22, wherein the payment unit to send the payment information to the payment system if the account credential information is successfully authenticated and payment information is stored in the system of the network partner.

25. A method of processing a payment transaction between a consumer and a merchant, the method comprising:
initiating, with a payment system, the payment transaction between the consumer and the merchant;
receiving, with the payment system, a mobile phone number from the consumer;
determining, with the payment system, whether the consumer is eligible for payment network processing utilizing a network partner based on the received mobile phone number; and
receiving account credential information, with the payment system, for the consumer with the network partner if the consumer is eligible for payment network processing.

26. The method of claim 25, further comprises:
determining whether the account credential information is associated with the received mobile number and a payment method.

27. The method of claim 26, further comprises:
receiving payment information, with the payment system, for the consumer from the network partner if the account credential information is associated with the received mobile number and a payment method; and
processing the payment transaction, with the payment system, on behalf of the merchant.
